(19) United States
(12) Patent Application Publication
(10) Pub. No.: US 2011/0232540 A1
(43) Pub. Date: Sep. 29, 2011

(54) MOBILE SUPPORT FOR NOTEBOOKS, PORTABLE COMPUTERS AND THE LIKE

(75) Inventor: Andrea Benoni, Cavaion (IT)

(73) Assignee: Interactive Net Business S.R.L. ET AL., Verona (IT)

(21) Appl. No.: 12/673,744

(22) PCT Filed: Aug. 14, 2008
(86) PCT No.: PCT/IT2008/000551

§ 371 Date: Jun. 14, 2011

(30) Foreign Application Priority Data
Aug. 17, 2007 (IT) VR2007A000120

(51) Int. Cl. A47B 21/013; F16M 11/18

(52) U.S. Cl. 108/59; 248/371

(57) ABSTRACT

A mobile support for notebooks, portable computers and the like, which foresees a vertical bar (11), with a tripod (12) to stand on the floor, equipped with an arm (13), which is fixed horizontally and only adjustable vertically, holding a tray (14) for the notebook and mounted on a joint which can be blocked by clamping means (23), the feet (17) of the vertical bar being foldable and if necessary equipped with roller wheels (19), while the tray can be rotated and inclined and blocked in place by means of the clamping means (23).

### TECHNICAL FIELD

This invention concerns a mobile support for notebooks, portable computers and the like.

More specifically, this invention refers to a mobile support for notebooks and the like which can offer a series of practical advantages with respect to traditional solutions concerning known supports for notebooks.

The device according to the invention consists of a support whose main feature distinguishing it from other products is that it is equipped with a particular articulated arm that can be rotated 360 degrees and inclined, making it possible to move the computer closer to the user without the structure being an obstacle (greater flexibility), thus obtaining a structure that takes up little space, is very sturdy and can at the same time be moved close to armchairs, beds and office chairs.

The structure according to the invention meets the requirements of a market that is expanding very rapidly and which has not yet been provided with efficient solutions.

This invention can be applied in the sector of accessory items for the office or home, in particular computer accessories for notebooks and the like.

### BACKGROUND ART

Solutions concerning mobile supports for notebooks have been available for some time, these substantially being portable computers which can be used in a wide variety of situations, ranging from the home to the office to outdoors.

There are various support solutions of this type, the main ones being the single-piece book-rest type, without an arm to move the computer closer to the user.

There are also some complete solutions, which are different but not particularly versatile, in the sense that they cannot be fitted to different computers. They are also expensive, being custom-made directly by the computer manufacturer for a specific model.

Various solutions have attempted to solve the problem by being an integral part of the personal computer.

Background art also includes various types of supports for the bed or sofa, which however have a limited use due to the few degrees of freedom of the support and their somewhat rustic appearance. These structures also take up a considerable amount of space and their design does not allow ideal use.

There are also mobile supports designed for portable computers which attempt to satisfy the various requirements involved in their use.

These mobile supports include boards, which however present structural limitations relative to posture, as when the user is seated, his/her knees are lower than is ideal for looking at the screen. They are also inconvenient to use when lying down and after a while it is very uncomfortable to keep the support with the notebook with one's knees raised.

In general, the problems of known supports for notebooks basically concern the heat they produce if kept close to the body (modern portable computers generate a considerable amount of heat), non-ergonomical posture for the screen, the fact that the computer body is in one-piece creates problems because the screen is usually not on a level with the eyes and in trying to solve the problem the supports place the portable computer at an angle.

Traditional supports also lead to incorrect body posture since the height of standard furniture is not suitable for the use of portable computers, while specifically designed furniture attempts to encourage better posture.

Traditional supports for notebooks, moreover, do not allow their use in different situations (armchair, bed, lying down), an aspect which is very important when used at home.

In the case of supports with soft surfaces, there are also problems of overheating of the notebook, since a soft surface can block the ventilation holes.

None of the solutions present on the market is sufficiently universal, as demonstrated by the results of a market which is currently highly fragmented.

### DESCRIPTION OF THE INVENTION

This invention proposes to provide a mobile support for notebooks and the like, which can eliminate or at least reduce the drawbacks described above.

The invention also proposes to provide a mobile support for notebooks and the like, which is very simple to produce on a large scale in order to be economically advantageous.

This is achieved by means of a mobile support for notebooks, portable computers and the like, whose features are described in the main claim.

The dependent claims of the solution in question describe advantageous embodiments of the invention.

The main advantages of this solution, in addition to those deriving from the construction simplicity, concern first of all the fact that the invention foresees an arm that makes it possible to move the computer closer to the user without the structure being in the way, with a much greater flexibility compared to known solutions.

A further advantage is offered by the possibility, according to the invention, of using a particularly shaped base which provides the solution with maximum stability, obtained by means of substantially “Y” shaped feet, thus maximizing the area in which the barycentre of the support lies.

Additionally, the support according to the invention is not an invasive structure and can be positioned close to armchairs, beds or office chairs.

This support satisfies the needs of a rapidly growing market for which efficient solutions have not yet been provided.

The device according to the invention therefore substantially consists of a support for notebooks, portable computers and the like, which foresees the use of a vertical bar, with a tripod to stand on the floor, on which an arm is mounted which is fixed horizontally and adjustable only vertically.

The feet of the vertical bar can be folded together and are fitted with roller wheels, while the computer support can be rotated and inclined.

The support upright is a laser-cut and folded single-piece, while the arm is adjustable in height and moves horizontally with the body, making the structure more stable to prevent it moving outside its barycentre.

It can be locked in position by means of a knob, and the two feet engage with the base and converge only at the rear, where the plastic which holds them together also acts as a base.

The plastic feet are an alternative to the wheels and provide the support with greater stability.

Another knob makes it possible to block rotation of the support and the inclination angle.

The computer support base is laser-perforated to ensure better ventilation and to make it more attractive, and the height adjustment allows it to be used when seated in an armchair, on a chair or lying on a bed.

The working length of the arm is 40 cm, making it easy to use in the various conditions foreseen (distance from the edge).

The vertical upright can be fitted with a platform for the use of a mouse or as a support for accessories.

The device can also be fitted with a horizontal joint on the arm and with wheels, and with a support for the computer powerpack and cable guides on a more sophisticated model.

### DESCRIPTION OF THE DRAWINGS

Other features and advantages of the invention will become more clear on reading the description given below of one embodiment of the invention, provided as a non-binding example, with the help of the accompanying drawings in which:

FIG. 1 represents a schematic plan view of the base of the support;

FIG. 2 is a schematic side view of a detail of the base;

FIG. 3 is a schematic side view of the overall structure;

FIG. 4 is a schematic side view of the upright and the arm connected to it;

FIG. 5 is a view of the tray of the support;

FIGS. 6 and 7 are schematic views showing the shape of the central part of the base;

FIGS. 8 to 11 are views of support elements or tubular feet of the vertical upright, fitted to the central part of the base;

FIGS. 12 to 19 are schematic views showing the support surface or tray;

FIGS. 20 to 27 are schematic views showing the side support for the mouse;

FIG. 28 shows a prospective overall view of the mobile support;

FIG. 29 is a schematic view of the lower part of the device, showing the base assembly.

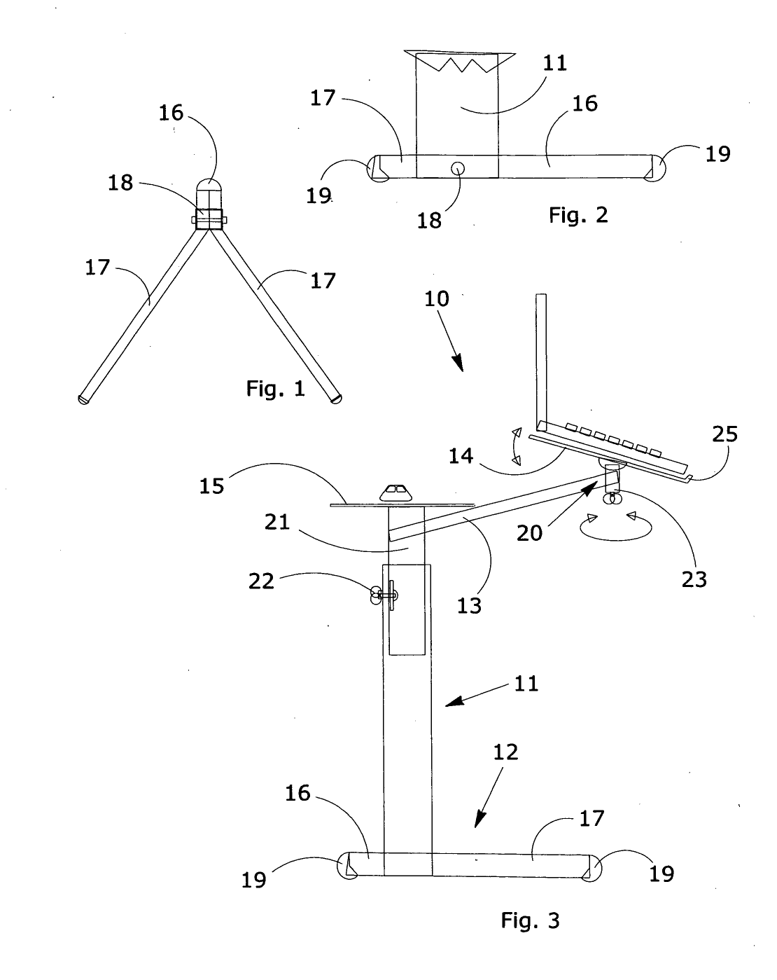

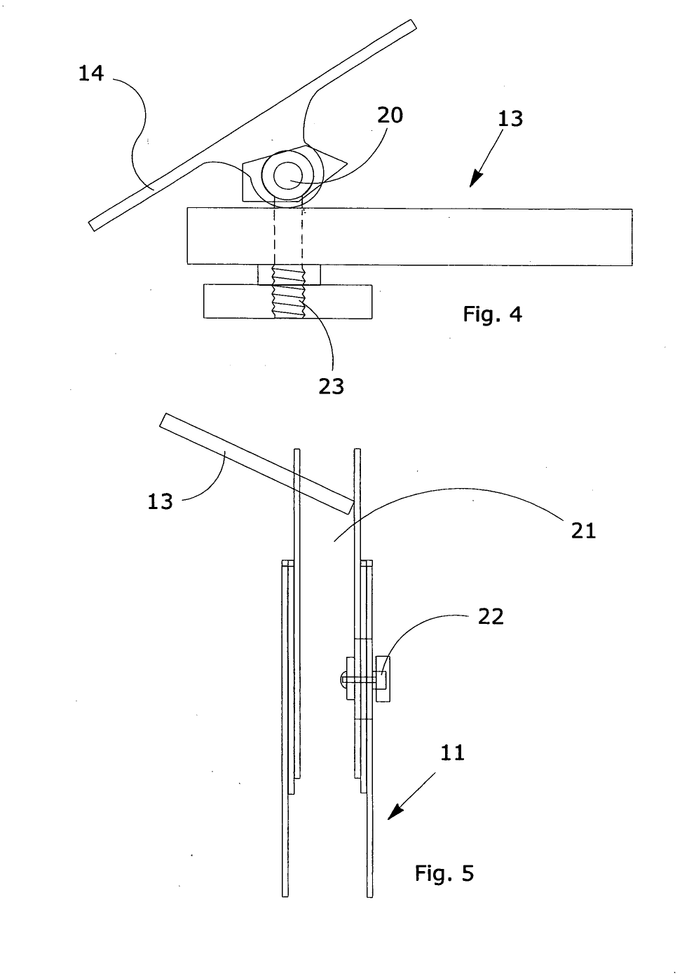

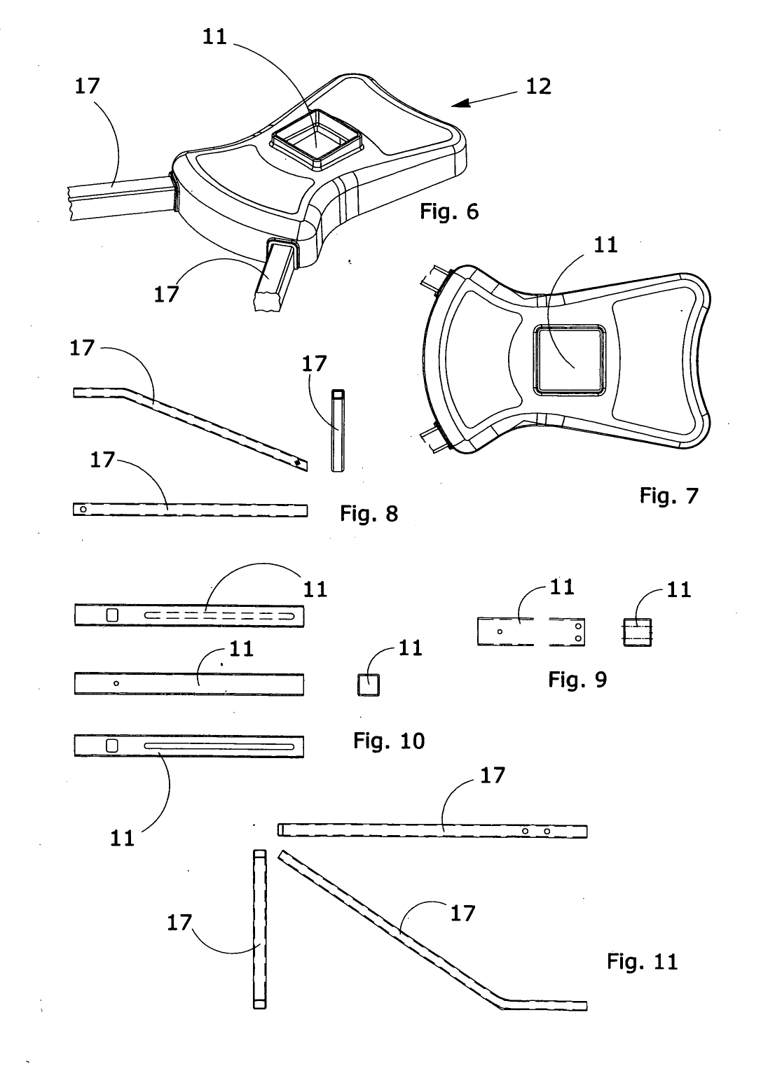

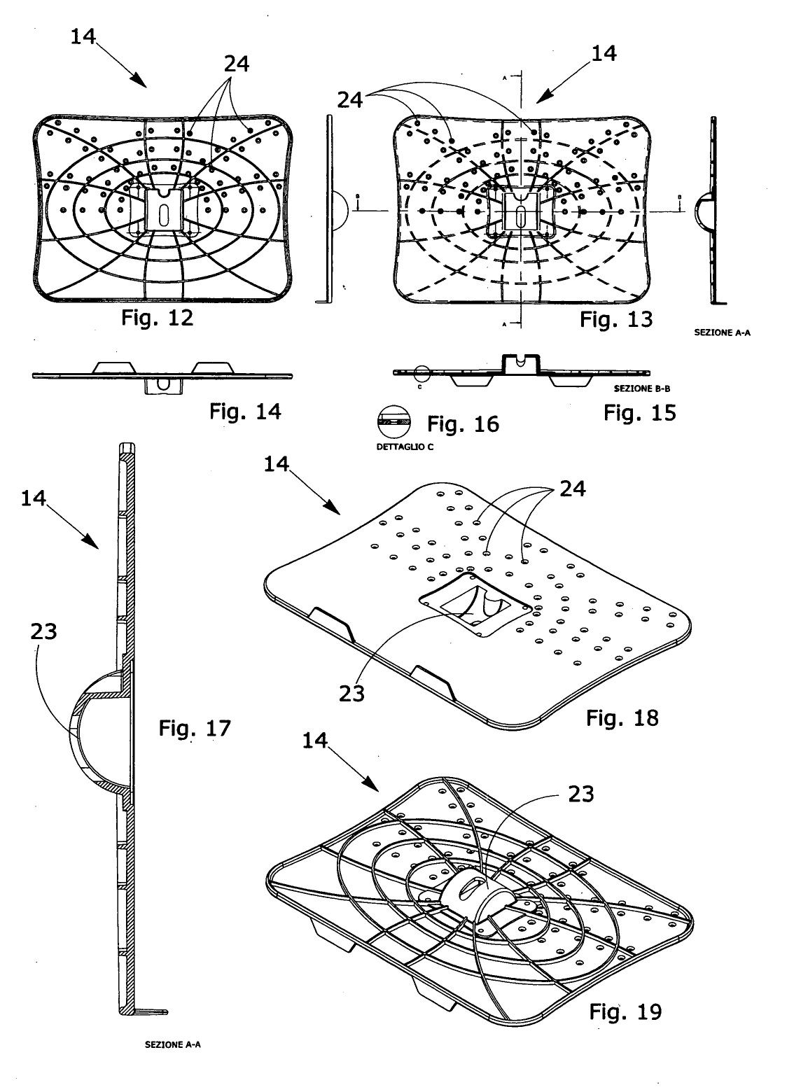

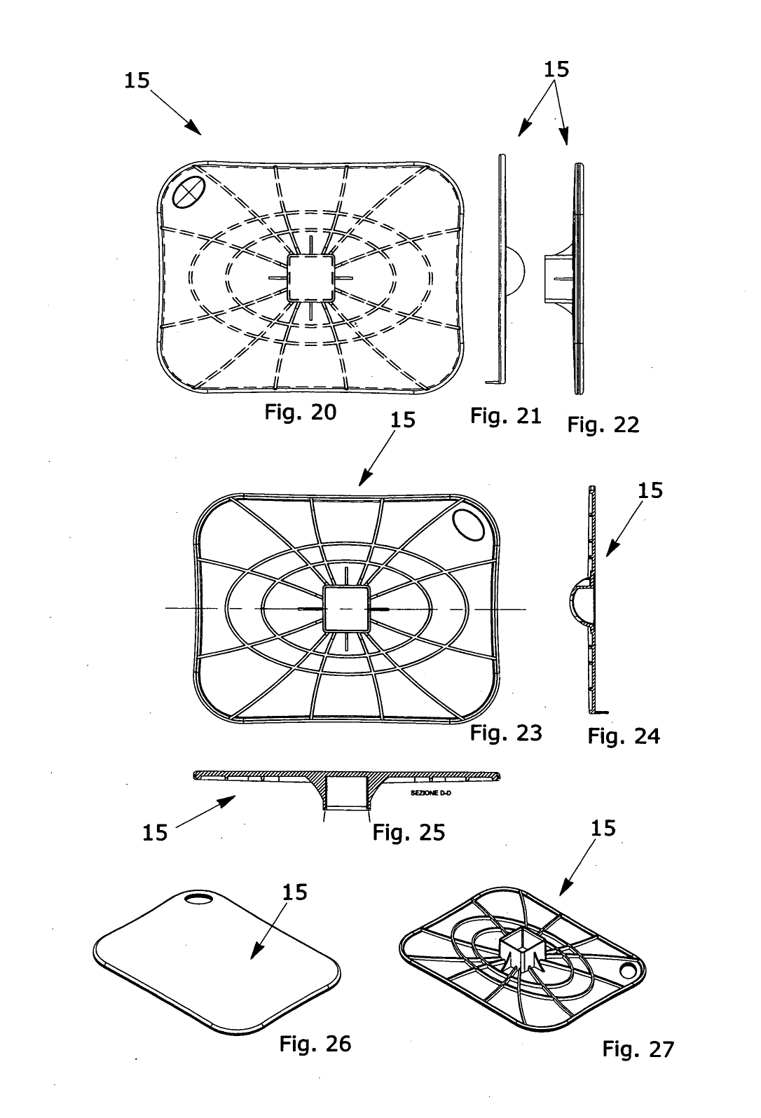

### DESCRIPTION OF ONE EMBODIMENT OF THE INVENTION

With reference to the accompanying drawings, the mobile support for notebooks, portable computers and the like, indicated overall with the number 10 in FIG. 3, substantially consists of a vertical bar or upright 11, fitted with a tripod 12 to stand on the floor.

The upright 11 is equipped with an arm 13 which is fixed horizontally and only adjustable vertically, fitted with a tray 14 for notebooks and the like.

The upright 11 is also equipped with a platform 15 for the use of a mouse or as a support for accessories.

The tripod 12 of the vertical bar consists of a rear foot 16 and two front feet 17 which are longer than the rear foot, which can all be attached to a joint 18 and fitted with roller wheels 19. The rear foot 16 and the two front feet 17 form a substantially “Y” shaped base, making the structure particularly stable.

The end of the arm 13 is equipped with a joint 20 which can be rotated and inclined, and to which the tray 14 for the portable computer is attached.

The upright 11 of the support 10 is a laser-cut and folded single-piece, while the arm 13 is the telescopic type with an inner sliding tube 21 which is adjustable only in height and moves horizontally with body of the support, making the structure more secure to prevent it moving outside the barycentre and more stable to prevent vibration of the computer when it is used.

The inner sliding tube 21 of the arm 13 is blocked in place by means of a knob 22 which by tightening a plate blocks the three parts (inner tube, sliding plastic tube, outer support body), thus providing good stability and reducing vibrations. The two feet engage with the base, converging at the rear 16, where the plastic holds them in place and also acts as another foot.

The feet 16 and 17 of the tripod are made from plastic and ensure reliable stability.

Another knob 23 blocks the joint of the tray 14, preventing rotation and inclination. The shape of the joint allows the tray to be inclined within a certain range, thus preventing positions that are not secure. The knob 23 can be loosened to allow rotation and inclination of the computer tray.

The base of the tray 14, which has a riser 25 to hold the notebook in place, presents a plurality of holes 24 to ensure better ventilation and make it more attractive.

The adjustable height of the upright allows the device to be used when seated in an armchair or when lying in bed.

The arm 13 has an indicative working length of 40 cm, allowing it to be used in the various conditions (distance from the edge).

The device can be fitted with a horizontal joint on the arm and with wheels, and also a support for the computer powerpack and cable guides on a more sophisticated model.

The size of the packaging is mainly conditioned by the size of the computer tray 14 and this may be modified in future to provide a folding version.

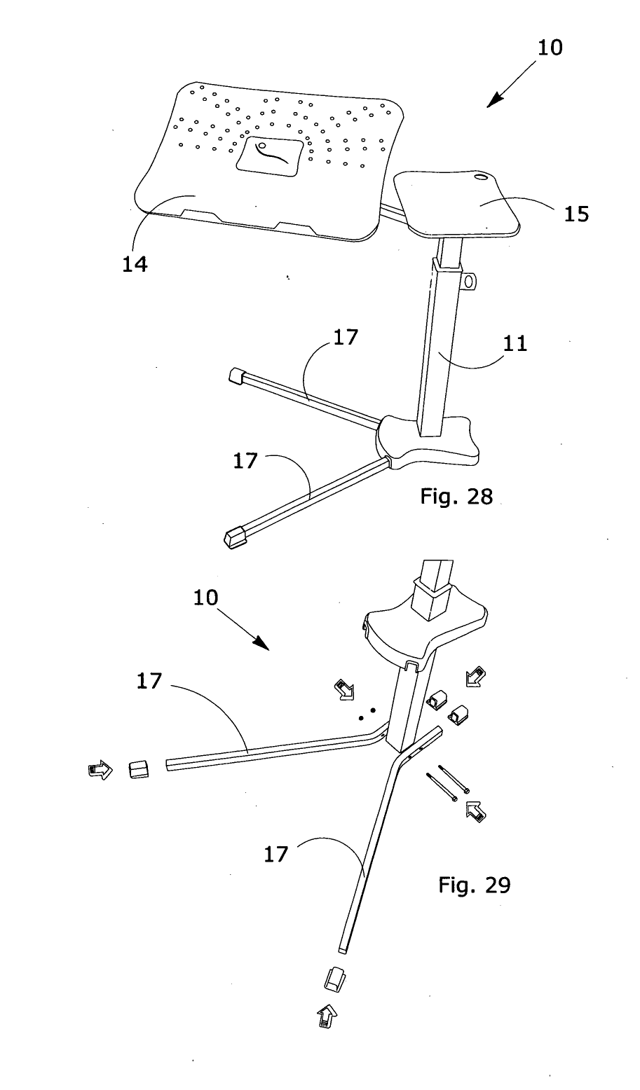

As can be seen in FIGS. 28 and 29, one of the main features of the invention is the considerable stability of the structure, due to the characteristic shape of the base feet which, if seen in plan view, present a “Y” shape.

The base is in fact wider exactly where there is most weight of the object placed on the tray 14, corresponding to the weight of the portable computer and of the arm of the person using it.

Tests carried out have shown that this particular “Y” shape of the base and the low barycentre of the structure make the device more stable when it is being used.

Again from the point of view of stability, the structure according to the invention comprises parts developed on the basis of studies specifically carried out to solve the problem of vibration, such as the shape of the feet without wheels, the connections to the base, and the shape of the joints which was optimised to increase the stability and prevent the generation or spread of vibrations.

To summarise, the parts which characterise the structure according to the invention are substantially as follows:
a) An arm which allows the computer to be moved away from the upright, making it easy to use with no obstacles for the user;
b) A joint with 360° rotation and 35° inclination, allowing a wide range of positions other than alongside the user as with competitive products;
c) An optimised base design to ensure stability while keeping the barycentre within the sphere of the structure even when moved or knocked;
d) An optimised tray design with risers to keep the computer in place when used at an angle and with ventilation holes.

The invention is described above with reference to a preferred embodiment. It is nevertheless clear that the invention is susceptible to numerous variations which lie within the scope of its disclosure, in the framework of technical equivalents.

1-14. (canceled)

15. A mobile support for a notebook, a portable computer and the like, the device comprising a vertical bar with a tripod to stand on the floor, an arm fixed horizontally and selectively adjustable vertically for holding a tray for a notebook and mounted on a joint, the joint being blockable by a clamp, feet of the vertical bar being foldable and selectively equipped with roller wheels, and the tray being rotatable and inclinable and blockable by the clamp.

16. A mobile support as claimed in claim 15, wherein the upright of the support is a laser-cut and folded single-piece.

17. A mobile support as claimed in claim 15, wherein the tripod includes a rear foot and two front feet longer than the rear foot, the feet being foldable together by a joint, and including roller wheels.

18. A mobile support as claimed in claim 15, wherein the arm is only adjustable in height on a telescopic inner sliding tube and movable horizontally with the body, thereby making the structure more secure to hinder its moving outside its barycenter and render it more stable to prevent vibration during use.

19. A mobile support as claimed in claim 15, the blocking of the arm being effected by a knob for clamping the upright with an inner sliding tube to which the arm is fixed, thereby allowing adjustment in height and blocking, and the feet engaging with the base and converging at the rear, including a plastic base for holding components together and acting as a foot.

20. A mobile support as claimed in claim 15, wherein the feet of the tripod are made from plastic.

21. A mobile support as claimed in claim 15 including a knob for blocking a computer tray in place thereby to hinder rotation and inclination.

22. A mobile support as claimed in claim 15, wherein a knob functionally blocks both the rotation and the inclination of the computer tray.

23. A mobile support as claimed in claim 15 including a joint for a computer tray with a limit stop, thereby permitting movement only within an inclination safety limit.

24. A mobile support as claimed in claim 15, comprising a computer tray having a plurality of holes for ventilation.

25. A mobile support as claimed in claim 15, wherein the arm has an indicative working length of around 40 cm.

26. A mobile support as claimed in claim 15, comprising a platform for the use of a mouse or as a peripheral support positioned on the upright.

27. A mobile support as claimed in claim 15 including a horizontal joint on the arm and including wheels, and a support suitable for the powerpack and the cable guides.

28. A mobile support as claimed in claim 15, including a computer tray for presenting a riser for holding a notebook in place.
